(19) United States
(12) Patent Application Publication
(10) Pub. No.: US 2023/0219833 A1
(43) Pub. Date: Jul. 13, 2023

(54) WASTEWATER TREATMENT SYSTEMS AND METHODS OF USE

(71) Applicant: Inventus Holdings, LLC, Juno Beach, FL (US)

(72) Inventor: Eric J. Lohan, Juno Beach, FL (US)

(21) Appl. No.: 17/575,627

(22) Filed: Jan. 13, 2022

(51) Int. Cl. C02F 3/30; C02F 3/32; C02F 3/00; C02F 3/06

(52) U.S. Cl. CPC C02F 3/305; C02F 3/327; C02F 3/006; C02F 3/06; C02F 3/307; C02F 2209/44; C02F 2209/22; C02F 2209/04; C02F 2209/06; C02F 2209/02; C02F 2209/05; C02F 2209/14; C02F 2209/15; C02F 2101/163

(57) ABSTRACT

A wastewater treatment system includes two or more wastewater treatment reactors selected from an anoxic wastewater treatment reactor, a flex wastewater treatment reactor, and a hydroponic wastewater treatment reactor in fluid communication with and connecting a wastewater system inlet and a treated wastewater system outlet, each of the anoxic reactor, the flex reactor, or the hydroponic reactor including a reactor inlet for receiving wastewater to be treated and a reactor outlet directing treated wastewater from the anoxic reactor, the flex reactor, or the hydroponic reactor. The system also includes: (i) either but not both of the anoxic reactor or the flex reactor, (ii) a hydroponic reactor if the anoxic reactor is included, and (iii) at least two flex reactors if the hydroponic reactor is absent, and wherein at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

### BACKGROUND

Water scarcity and rising water rates in many urban and suburban areas are an increasing concern for hospitals, universities, and industries. Decentralized wastewater treatment and reuse systems can reduce costs and improve resiliency for many of these users by reclaiming wastewater for non-potable uses, such as irrigation, toilet flushing, and utility water make-up.

Reclaiming wastewater generally requires biological treatment processes that convert dissolved organic material and nutrients into gasses or biological material that can be efficiently separated from the clean water prior to disinfection and reuse. A wide variety of wastewater processes have been developed to treat municipal and industrial wastewater yet decentralized treatment applications frequently require a much smaller system footprint. However, wastewater treatment processes optimized for small footprints are characterized by high energy use. In municipal and industrial wastewater treatment nitrogen removal or final filtration through submerged membranes are often the two most energy intensive parts of the process. Typically, nitrogen is removed in two or three step processes involving changes of redox conditions to convert ammonium to nitrite then nitrate, and subsequently dinitrogen gas. The oxidation of ammonium to nitrite and nitrate are typically catalyzed with autotrophic organisms which are very slow growing and susceptible to system upset.

One method of further reducing system footprint is to incorporate fixed film processes with suspended processes. The inclusion of biocarriers allow fixed film communities to be incorporated into suspended growth wastewater treatment process. However, this can often increase energy use where biocarriers require coarse bubble aeration for agitation and scouring. The inclusion of biocarriers can also adversely affect the ability of the system mixed liquor from being effectively filtered as floc characteristics can be smaller.

### SUMMARY

The present disclosure relates to systems and methods for the treatment of wastewater. The wastewater treatment system can be capable of nitrogen removal from wastewater while reducing both the system footprint and energy use relative to previously described membrane bioreactor (MBR) based wastewater treatment systems.

In some embodiments, the wastewater treatment system includes two or more wastewater treatment reactors in fluid communication with and connecting a wastewater system inlet and a treated wastewater system outlet. The wastewater treatment reactors of the system are selected from an anoxic wastewater treatment reactor, a flex wastewater treatment reactor, and a hydroponic wastewater treatment reactor. Each of the anoxic reactor, the flex reactor, or the hydroponic reactor include a reactor inlet for receiving wastewater to be treated and a reactor outlet directing treated wastewater from the anoxic reactor, the flex reactor, or the hydroponic reactor. The system includes: (i) either but not both of the anoxic reactor or the flex reactor. (ii) a hydroponic reactor if the anoxic reactor is included, and (iii) at least two flex reactors if the hydroponic reactor is absent. In addition, at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

In some embodiments, the system includes the anoxic reactor and the hydroponic reactor. In some embodiments, the anoxic reactor includes a mechanical mixing device and does not include a fixed film.

In other embodiments, the system includes the flex reactor and the hydroponic reactor. In some embodiments, the system can include at least two flex reactors. The hydroponic reactor can be downstream of the anoxic reactor or the flex reactor.

The flex reactor can include an inlet for receiving wastewater to be treated, an outlet, a submerged fixed film, a mechanical mixing device, and an intermittent or pulsed aeration device. The flex reactor can be capable of alternating between anoxic and aerobic modes. In some embodiments, the hydroponic reactor can include a mechanical mixing device.

The intermittent or pulsed aeration device of at least one of the flex reactor or the hydroponic reactor can allow for simultaneous nitrification and denitrification (SND) in the individual flex reactor or hydroponic reactor.

In some embodiments, the flex reactor and the hydroponic reactor both include an intermittent or pulsed aeration device, and the intermittent or pulsed aeration devices of both the flex reactor and the hydroponic reactor are components of a single intermittent or pulsed aeration system.

In other embodiments, the flex reactor and hydroponic reactor do not include an intermittent or pulsed aeration device. In some embodiments, the submerged membrane or submerged root zone allows for simultaneous nitrification and denitrification (SND) in the individual flex reactor or hydroponic reactor.

In some embodiments, the flex reactor or the hydroponic reactor include a submerged fixed film substrate. The submerged fixed film substrate of the hydroponic reactor can include a fixed film from plant roots. In some embodiments, the hydroponic reactor includes a basin that defines an inlet and an outlet and includes a rack positionable at a surface of water in the basin for supporting plants thereon. The rack may cover substantially the entire surface of the basin and, in use, plants may cover about 50% or more of the surface area of the rack. The plants in the hydroponic reactor are adapted to retain biofilms on roots for enhancing nutrient removal.

In some embodiments, the wastewater treatment system further includes a submerged membrane tank or external membrane system in fluid communication with and downstream of the two or more wastewater treatment reactors. In some embodiments, a portion of the water exiting from the submerged tank or external membrane system is directed to at least one of the two or more wastewater treatment reactors upstream of the submerged membrane for further treatment. In some embodiments, the submerged membrane tank includes a submerged ceramic membrane. In some embodiments, the external membrane system is an external tubular membrane system.

In some embodiments, the wastewater treatment system further includes one or more additional wastewater treatment reactors in fluid communication with and connected to the two or more wastewater treatment reactors. The additional wastewater treatment reactor can include at least one aerobic wastewater treatment reactor. The aerobic reactor can include an aeration device for aerobic conditions. In some embodiments the aerobic reactor is downstream of the anoxic reactor or the flex reactor of the two or more wastewater treatment reactors.

Additional embodiments described herein relate to a method of treating wastewater. The method includes treating wastewater with or in two or more wastewater treatment reactors selected from an anoxic wastewater treatment reactor, flex wastewater treatment reactor, or hydroponic wastewater treatment reactor, wherein the wastewater is treated with: (i) either but not both of the anoxic reactor or the flex reactor, (ii) a hydroponic reactor if the wastewater is not treated with anoxic reactor, and (iii) at least two flex reactors if the wastewater is not treated with the hydroponic reactor. At least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

In some embodiments, the wastewater is treated with the anoxic reactor and the hydroponic reactor. In some embodiments, the wastewater in the anoxic reactor is mechanically mixed and the anoxic reactor does not include a fixed film.

In other embodiments, the wastewater is treated with the flex reactor and the hydroponic reactor. In some embodiments, the wastewater is treated with at least two flex reactors. The wastewater is treated with the hydroponic reactor after treatment with the anoxic reactor or the flex reactor.

In some embodiments, the wastewater is treated in a flex reactor that includes an inlet for receiving wastewater to be treated, an outlet, a submerged fixed film, a mechanical mixing device, and an intermittent or pulsed aeration device. The flex reactor can be capable of alternating between anoxic and aerobic modes. In some embodiments, the method comprises mechanically mixing wastewater in the hydroponic reactor.

In some embodiments, the wastewater treated in at least one of the flex reactor or the hydroponic reactor is treated using simultaneous nitrification and denitrification (SND) in the individual flex reactor or hydroponic reactor.

In some embodiments, the wastewater treated in both the flex reactor and the hydroponic reactor is intermittently or pulse aerated. The intermittent or pulsed aeration devices of both the flex wastewater treatment reactor and the hydroponic wastewater reactor can be components of a single intermittent or pulsed aeration system.

In other embodiments, the wastewater treated in the flex reactor and the hydroponic reactor is not intermittently or pulse aerated. In some embodiments, the submerged membrane or submerged root zone allows for the wastewater to be treated using simultaneous nitrification and denitrification (SND) in the individual flex or hydroponic reactor.

In some embodiments, the wastewater is treated in at least one of the flex reactor or the hydroponic reactor including a submerged fixed film substrate. The submerged fixed film substrate of the hydroponic reactor can include a fixed film from plant roots. In some embodiments, the hydroponic reactor includes a basin that defines an inlet and an outlet and includes a rack positionable at a surface of water in the basin for supporting plants thereon. The rack may cover substantially the entire surface of the basin and, in use, plants may cover about 50% or more of the surface area of the rack. The plants in the hydroponic reactor are adapted to retain biofilms on roots for enhancing nutrient removal.

In some embodiments, the wastewater is further treated in a submerged membrane tank or external membrane system in fluid communication with and downstream of the two or more wastewater reactors. In some embodiments, a portion of the water exiting from the submerged tank or external membrane system is treated in at least one of the two or more wastewater treatment reactors upstream of the submerged membrane or external membrane system for further treatment. In some embodiments, the submerged membrane tank includes a submerged ceramic membrane. In some embodiments, the external membrane system includes an external tubular membrane system.

In some embodiments, the wastewater is treated in one or more additional wastewater treatment reactors in fluid communication with and connected to the two or more wastewater treatment reactors. In some embodiments, the wastewater is treated in at least one aerobic wastewater treatment reactor. The aerobic reactor can include an aeration device for aerobic conditions. In some embodiments, the wastewater is treated in at least one aerobic reactor downstream of the anoxic reactor or the flex reactor of the two or more wastewater treatment reactors.

In certain embodiments, treatment of wastewater in at least one of the flex reactor or the hydroponic reactor includes intermittently or pulse aerating the wastewater, and regulating intermittent or pulsed aeration according to the measurement or detection of a variable in the wastewater treatment reactor. In some embodiments, treatment of wastewater includes controlling the duration of an aeration period of intermittent or pulsed aeration by measuring or detecting a variable in the wastewater treatment reactor, and interrupting the air supply if a threshold value of the measured or detected variable is reached before a set period of time. The measured or detected variable can be selected from a level of dissolved oxygen (DO), oxidation-reduction potential (ORP), conductivity, temperature, pH, ammonia concentration, nitrite concentration, nitrate concentration, ratio of ammonia concentration to an oxidized nitrogen (NOx) concentration, and combinations thereof. In some embodiments, the measured or detected variable in the wastewater treatment reactor is maintained between two set threshold values, and is managed by a computer or controlling device which, in real time, integrates the detection or measurements to modulate the air supply in the reactor.

In other embodiments, treatment of wastewater in at least one of the flex reactor or the hydroponic reactor includes intermittently or pulse aerating the wastewater and regulating intermittent or pulsed aeration using a timer device.

In some embodiments, treatment of wastewater in at least one of the flex reactor or the hydroponic reactor includes an anoxic duration of treatment where the DO concentration of the wastewater is maintained between about 0.25 mg/L and about 0.75 mg/L. In some embodiments, treatment of wastewater in at least one of the flex reactor or the hydroponic reactor includes an anoxic duration of treatment where the ORP of the wastewater is maintained between about 125 mV and about 200 mV.

### BRIEF DESCRIPTION OF THE DRAWINGS

FIG. 1 is an illustration of a wastewater treatment system in accordance with embodiments that includes a flex reactor and a hydroponic reactor, where both treatment reactors utilize intermittent/pulse aeration to allow for simultaneous nitrification and denitrification (SND) in the individual treatment reactors.

FIG. 2 is a schematic diagram of a wastewater treatment system in accordance with the first embodiment.

FIG. 3 is a schematic diagram of a wastewater treatment system in accordance with the second embodiment.

FIG. 4 is a cross-sectional view of a hydroponic reactor.

FIG. 5 is a schematic diagram of a wastewater treatment system in accordance with the third embodiment.

FIG. 6 is a schematic diagram of a wastewater treatment system in accordance with the fourth embodiment.

FIG. 7 is a schematic diagram of a wastewater treatment system in accordance with the fifth embodiment.

FIG. 8 is a schematic diagram of a wastewater treatment system in accordance with the sixth embodiment.

### DESCRIPTION

The present disclosure provides wastewater treatment systems capable of nitrogen removal from wastewater while reducing both the system footprint and energy use relative to previously described membrane bioreactor (MBR) based wastewater treatment systems. The wastewater treatment systems and methods of use described herein are amenable to the treatment of, for example, but not intended to be limited to, domestic wastewater, industrial waste or process water, stormwater, urban runoff, agricultural wastewater or runoff, and even biological sludges. The types of contaminants that can be treated in the systems include suspended particles, nutrients, metals, simple organics (oxygen-demanding substances), and synthetic or complex organics.

In some embodiments, a wastewater treatment system can include two or more wastewater treatment reactors in fluid communication with and connecting a wastewater system inlet and a treated wastewater system outlet. Each wastewater treatment reactor of a wastewater treatment system is for treating the wastewater with a selected wastewater treatment process, thus permitting sequential treatment of the wastewater in the system by a plurality of processes.

Each wastewater treatment reactor includes a reactor inlet for receiving wastewater to be treated and a reactor outlet directing treated wastewater from the wastewater treatment reactor. Influent wastewater is directed to a selected wastewater treatment reactor which achieves, for example, removal of organics and solids as well as provides denitrification. Following treatment for a period of time in a wastewater treatment reactor, treated water is directed from the reactor outlet, such as by pumping or gravity flow, to the reactor inlet of the next downstream wastewater treatment reactor of the system for further processing. A given treatment reactor may operate as a complete or partial mix bulk liquid reactor. Alternatively, the reactor may operate in a fill and drain, or a fill and draw mode.

In some embodiments, the two or more wastewater treatment reactors for use in a wastewater treatment system can be selected from an anoxic wastewater treatment reactor, a flex wastewater treatment reactor and hydroponic wastewater treatment reactor that are in fluid communication with and connecting a wastewater system inlet and a treated wastewater system outlet.

In some embodiments, a wastewater treatment system includes an anoxic reactor that can operate in a substantially anoxic mode and is useful for nitrogen removal from wastewater. Some wastewater can have a high nitrogen content, and the anoxic treatment process can achieve a removal of dissolved nitrogen compounds by, for example, microorganism biodegradation of the nitrogen compounds to nitrogen gas. Given that biodegradation of oxidized nitrogen compounds in an anoxic reactor naturally can provide terminal electron acceptor required for bacterial growth, the bacteria in anoxic reactors do not require supplemental oxygen from diffusers or surface aerators.

In some embodiments, an anoxic treatment reactor for use in a system described herein can utilize a suspended-growth system, where the wastewater flows around and through free floating microorganisms, gathering into biological flocs. The flocs can then retain the microorganisms and be recycled for further treatment or wasted from the system.

In typical embodiments, attached media is not utilized in an anoxic treatment reactor. Where attached media is utilized in an anoxic reactor, the attached media can include attached-growth systems in medium to retain and grow microorganisms. Attached-growth systems for use in an anoxic reactor can include, but are not limited to, moving bed bioreactors (MBBR) and fixed bed bioreactors (FBBR). FBBRs can include thousands of tiny media components packed into tight chambers where media components remain immobile, and their large surface area attracts beneficial microorganisms, which settle on the surface and form a biofilm. MBBRs typically include thousands of tiny media carriers suspended throughout the wastewater in a large tank.

In other embodiments, the wastewater treatment system can include a flex reactor that is capable of operating by alternating between anoxic and aerobic modes. The flex reactor can include suspended and fixed film microorganism communities, such as bacterial communities, to remove nitrogen compounds in the wastewater. Where the treatment reactor is a flex reactor, intermittent or pulsed aeration can be employed during wastewater treatment. The intermittent or pulsed aeration of suspended and fixed film bacterial communities in a flex reactor for use in a wastewater treatment system described herein can be used to control or modulate the nitrogen removal pathways of treatment bacteria. Intermittent or pulsed aeration of suspended and fixed film bacterial communities in the treatment reactors excludes or inhibits the growth of autotrophic nitrite oxidizing bacteria and fosters or promotes a variety of more efficient nitrogen removal pathways. This ability to more precisely control the nitrification and/or denitrification of treatment microorganisms, such as bacteria, in the inventive system results in lower energy use and reactor footprint as treatment microorganisms nitrify and denitrify in a single treatment reactor. Simultaneous nitrification and denitrification (SND) in a single individual treatment reactor is highly desirable compared to the conventional multitank systems since separate tanks and recycling of a mixed liquor nitrate from the aerobic nitrifying zone to an anoxic denitrifying zone is not required.

In an aerobic environment, nitrite oxidation typically follows ammonia oxidation. When aeration is continued (i.e., aeration is turned “on” in the treatment reactor), the nitrite produced by ammonia oxidizing bacteria (AOB) will eventually be converted to nitrate by nitrite oxidizing bacteria (NOB). However, if aeration is discontinued (i.e., aeration is turned “off”), and the conditions are allowed to rapidly transition to anoxia, then autotrophic nitrite oxidizing bacteria will be excluded allowing alternating nitrogen removal pathways to dominate depending on loading rates and aeration conditions. One alternate pathway includes ‘short-cut’ denitrification via nitrite. Therefore, intermittent or pulsed aeration of the wastewater in a treatment reactor described herein allows for: (1) an aerated first nitritation stage, during which complete or partial oxidation of ammonia via AOB in the aerobic environment produces nitrites; followed by (2) a nonaerated second denitritation stage under anoxic conditions to rapidly deplete dissolved oxygen (DO) levels in the wastewater, during which the nitrites are reduced to nitrogen gas via heterotrophic bacteria in the anoxic environment. Advantageously, successful suppression of nitrite oxidation by controlling NOB through intermittent or pulsed aeration reduces the system demand for oxygen and organic carbon compared to conventional nitrification-denitrification processes that proceed via further oxidation to nitrate and then subsequent denitrification. A second alternate pathway includes ammonium oxidation by heterotrophic nitrifiers which can denitrify in anoxic or micro-aerobic conditions via hydroxylamine, nitrite, or nitrate. A third alternate pathway includes nitrogen removal through anaerobic ammonium oxidation (‘Anammox’) process. In this pathway only a portion of ammonium is oxidized to nitrite by AOB. Remaining ammonium is oxidized and the resultant nitrite is utilized as a terminal electron directly producing dinitrogen gas by Anammox bacteria.

Optionally or alternatively, the flex reactor can include a submerged membrane that achieves a natural gradient of oxidative states that is similar to oxidative states achieved using the intermittent or pulsed aeration device. Therefore, in some embodiments, the flex reactor does not include an intermittent or pulsed aeration device as the submerged membrane itself allows for simultaneous nitrification and denitrification (SND) in the individual flex reactor.

In some embodiments, the wastewater treatment system reactor includes a hydroponic wastewater treatment reactor. The hydroponic reactor can include aquatic plants suspended atop the liquid for achieving aquatic-root-zone treatment. Hydroponic reactors provide fixed film communities without the use of costly synthetic attached growth media and the required screens to retain the media and are incorporated into a wastewater system described herein to reduce the system footprint and energy use. The hydroponic reactor is substantially aerobic and operates to achieve biological solid digestion in addition to continued removal of nutrients started in a previous or upstream treatment reactor.

A hydroponic reactor for use in a wastewater treatment system described herein can be intermittently or pulse aerated, as described above for use in a flex reactor, where the intermittent or pulsed aeration of suspended and fixed film microorganism communities, such as bacterial communities, in the hydroponic reactor is used to control or modulate nitrification and denitrification of treatment microorganisms. In some embodiments, a hydroponic reactor can comprise intermittently or pulsed aerated reactors that have a rigid rack set at the water surface to support plants with submerged roots or a submerged rootzone extending into a wastewater column thereby forming a fixed film from the submerged plant roots. The rack can cover substantially the entire water surface. Plants, preferably, substantially cover a high percentage of the surface of the rack. In some embodiments, plants cover at least about 35%, about 40%, about 50%, 60%, about 70%, about 80%, about 90%, about 95%, or more of the surface area of the rack.

In some embodiments, the submerged rootzone can achieve a natural gradient of oxidative states that is similar to oxidative states achieved in a hydroponic reactor using an intermittent or pulsed aeration device. From a microscopic perspective, the environment surrounding the plant root displays significant heterogeneity of oxidative reductive potential. Due to the slow movement of the plant roots in aerated reactors a thick layer of biofilms can develop along portions of the plant roots particularly at the densest part of the root ball. If the bulk liquid is maintained in an aerobic condition than the outer layer of the biofilm is oxic. With sufficient thickness or relatively low bulk dissolved oxygen concentrations the middle layer of the biofilm will become anoxic. Hydrophytes can survivor immersed in water because they transpire oxygen in the root zone to protect the root from reducing conditions. As a result, the biofilm immediately adjacent to the plant root is aerobic. This spatial transition from aerobic to anoxic to aerobic causes similar simultaneous nitrification and denitrification and is similar to the temporal variations of the pulsed aeration approach.

Similar to the submerged rootzone, the hydroponic reactor can also include a submerged membrane to support a biofilm that achieves a natural gradient of oxidative states as those achieved using an intermittent or pulsed aeration device. Therefore, in some embodiments, the hydroponic reactor does not include an intermittent or pulsed aeration device as the submerged membrane or submerged rootzone allows for simultaneous nitrification and denitrification (SND) in the individual hydroponic reactor.

In still other embodiments, the wastewater treatment system can include: (i) either but not both of the anoxic reactor or the flex reactor, (ii) a hydroponic reactor if the anoxic reactor is included, and (iii) at least two flex reactors if the hydroponic reactor is absent, and wherein at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

In some embodiments, the wastewater treatment system can include the anoxic reactor and the hydroponic reactor, or the flex reactor and the hydroponic reactor. In particular, the hydroponic reactor can be positioned downstream of the anoxic or the flex reactor such that the wastewater is treated with the anoxic reactor or flex reactor prior to treatment with the hydroponic reactor.

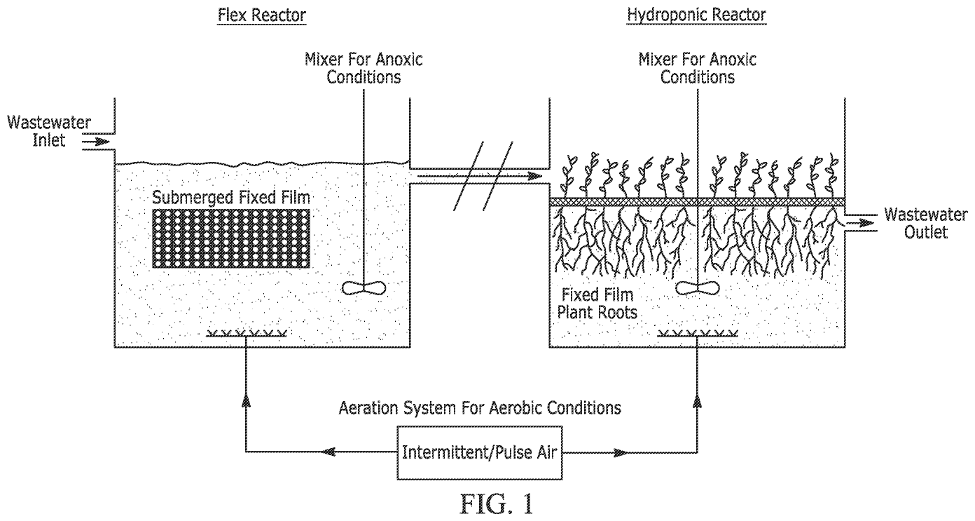

By way of example, FIG. 1 a wastewater treatment system in accordance with an embodiment described herein. The wastewater treatment system includes a flex reactor and a hydroponic reactor, where both reactors include a mixer for anoxic conditions and utilize intermittent/pulse aeration for aerobic conditions to allow for simultaneous nitrification and denitrification (SND) in the individual treatment reactors. In this embodiment, wastewater to be treated enters from a wastewater inlet for receiving wastewater into a flex reactor. Following treatment in the flex reactor for a predetermined period, the treated wastewater is directed from the flex reactor to a hydroponic reactor. Following treatment in the hydroponic reactor for a predetermined period, the treated wastewater is directed from the hydroponic reactor to a wastewater outlet for removing wastewater from the hydroponic reactor.

In certain embodiments, a wastewater treatment system described herein includes at least two flex reactors. For example, where the wastewater system does not include a hydroponic reactor, a wastewater treatment system can include two or more flex reactors that treat wastewater. The flex reactors can be separated in series between the wastewater inlet and treated water outlet by one or more anoxic and/or aerobic treatment reactors described herein such the wastewater is treated by a first flex reactor, one or more anoxic and/or aerobic treatment reactors, and then a second flex reactor.

In other embodiments, a wastewater treatment system can include a plurality of hydroponic reactors that are in direct fluid communication. In other embodiments, a wastewater treatment system can include a plurality of hydroponic reactors where the hydroponic reactors are in fluid communication but are separated in series between the wastewater system inlet and treated wastewater system outlet by one or more of the non-hydroponic reactors described herein.

It is to be appreciated that reference to two or more treatment reactors selected from an anoxic reactor, a flex reactor, and a hydroponic reactor in no way limits the total number or type of wastewater treatment reactors in a wastewater treatment system and additional treatment reactors can be added in series between the wastewater system inlet and the treated wastewater outlet as part of a wastewater system described herein.

In some embodiments, the additional wastewater treatment reactor in fluid communication with and connecting the wastewater system inlet and a treated wastewater system outlet can include an aerobic wastewater treatment reactor. Aerobic wastewater treatment reactors can be adapted to function essentially aerobically and may comprise an aeration system suitable for aerobic conditions. Aerobic reactors are typically used as part of a secondary treatment of wastewater after primary treatment has filtered out a substantial portion of the grit and large solid particles from the wastewater.

Aerobic reactors can employ one or more treatment processes including, but not limited to, activated sludge, fixed-bed bioreactors (FBBRs), moving-bed bioreactors (MBBRs), and membrane bioreactors (MBRs). An activated sludge process in an aerobic treatment reactor utilizes an aeration tank with aerators or diffusers. As the organic material in the waste breaks down, nutrients in the waste are consumed by microorganisms forming large bacteria-dominated chunks known as flocs. In a quiescent environment, the flocs then settle to the bottom of the tank, where they are easy to remove. The resulting activated sludge can then be fed back into earlier treatment processes or reactors so the bacteria can aid in waste breakdown. FBBRs for use in an aerobic treatment reactor can include thousands of tiny media components packed into tight chambers where the media components remain immobile, and their large surface area attracts beneficial microorganisms, which settle on the surfaces and form a biofilm. The microorganisms then help break down waste. Some of these chambers may also allow for anoxic denitrification zones allowing for nitrogen gas removal from the wastewater. MBBRs for use in an aerobic treatment reactor typically include thousands of tiny media carriers suspended throughout the wastewater in a large tank. The suspended media carriers of MBBRs float freely providing an extensive surface area and hospitable growing environment for beneficial microorganisms which facilitate the digestion of organic waste matter. MBRs are capable of efficiently treating wastewater due to their ability to create a high suspended solids treatment environment. MBRs typically work by combining activated sludge processes with membrane filtration where they treat the wastewater by effectively separating and recycling the suspended solids.

Aeration systems for an aerobic wastewater treatment reactor can include aspirating mixers, jet systems, micro or nanobubble systems, surface aerators or coarse or fine bubble diffusers to mix air into a wastewater column of the treatment reactor and keep treatment organisms suspended. With diffusers, the bubbles of air that rise from the bottom of the tank facilitate oxygen transfer. The presence of oxygen stimulates beneficial oxygen-feeding bacteria, protozoa, and other microbes in the water to help treat the wastewater by breaking down organic matter therein.

After a period of time in a final downstream wastewater treatment reactor of the wastewater system described herein, a portion of the wastewater can be directed, such as by pumping or gravity flow, to the treated wastewater system outlet for discharge. In some embodiments, the wastewater treatment system can also include a final or terminal wastewater treatment vessel including a submerged membrane tank having a vessel inlet and a vessel outlet. The vessel outlet or an external membrane system outlet can serve as the treated wastewater system outlet for discharge of the treated water from the wastewater system.

Submerged membranes of the vessel can include hollow strands or flat sheets of membrane material immersed in the tank of wastewater. In some embodiments, a pump is utilized to create a vacuum to pull water molecules into the hollow core of the strands, separating purified water from contaminants. The submerged membrane material can be selected from a polymeric membrane and a ceramic membrane suitable for wastewater treatment. Advantageously, a ceramic membrane can be utilized as the submerged membrane to allow for individual membranes to be periodically shut-off and further reduce energy consumption of the wastewater system and to improve performance with solids generated in the previous wastewater treatment reactors in the wastewater system, such as solids generated in a hydroponic reactor.

In some embodiments, the wastewater treatment system can include an external membrane system having an inlet and an outlet. The external membrane system can include an external tubular membrane system. An external tubular membrane system can utilize membrane filtration methods including, but not limited to, microfiltration, ultrafiltration, nanofiltration and reverse osmosis or a combination therein depending on the requirements of the wastewater treatment system.

In some embodiments, wastewater effluent exiting the submerged membrane tank outlet or external membrane system can be subjected to additional treatment such as ultraviolet disinfection before the treated wastewater emerging from the treated wastewater system outlet is suitable for release into the environment and/or reuse.

In optional embodiments, the wastewater treatment system can include a primary treatment process, prior to directing wastewater to a first wastewater treatment reactor, that serves to perform an initial organic and solids removal. An exemplary primary treatment process can include utilizing mechanical screens or rotating belt filters to remove solids. An alternate primary treatment process includes directing influent wastewater to a covered anaerobic reactor prior to directing the wastewater to the reactor inlet of the first wastewater treatment reactor. A covered anaerobic reactor can allow for the solids from the influent wastewater to settle and for anaerobic bacteria to feed on the solids and wastes. In some embodiments, the anaerobic screening reactor can include a filter for removing odors from gases that are produced therein.

In some embodiments, a portion of the treated wastewater that is not discharged from the wastewater system outlet can be directed (e.g., recycled) back into an upstream wastewater treatment reactor of the wastewater system for further processing prior to directing water exiting the submerged membrane tank and releasing treated water out of the wastewater system via the treated water outlet. In some embodiments, recycled treated wastewater, or a portion thereof, may be directed to the first wastewater treatment reactor of the wastewater treatment system or to an anaerobic pretreatment reactor immediately upstream in fluid communication with the first wastewater treatment reactor.

In some embodiments, the anoxic reactor, the flex reactor and/or the hydroponic reactor of the system described herein can include a mixing device to keep bacterial communities in the respective reactor in suspension. In certain embodiments, the mixing device when combined with intermittent or pulsed aeration of suspended and fixed film bacterial communities in a respective reactor, such as a flex or hydroponic reactor, can assist in controlling or modulating nitrification and denitrification of heterotrophic nitrifying bacteria in the wastewater treatment reactor.

Wastewater treatment systems described herein can utilize information from various probes or sensors located in a given wastewater treatment reactor, such as a flex reactor or hydroponic reactor utilizing intermittent or pulsed aeration. The probes or sensors allow for controlling the course of the biological wastewater treatment process during the aeration and non-aeration phases of processing and determining the duration thereof. In some embodiments, the probes or sensors are connected to a computer or controlling device which integrates the measurements in real time and thus allows the treatment to proceed in automatic mode.

Therefore, in some embodiments, a wastewater treatment reactor, such as a flex or hydroponic reactor described herein, can include a probe or sensor to measure or detect a variable and generate a corresponding signal. Variables measured or detected can include, but are not limited to, dissolved oxygen O₂ or DO concentration, oxidation-reduction potential (ORP) conductivity, temperature T, pH, ammonia concentration, nitrite concentration, nitrate concentration, ratio of ammonia concentration to the oxidized nitrogen (NOx) concentration, and combinations thereof. In operation, sensors can be used to determine the intermittent or pulsed air “on” and “off” period durations in an intermittent or pulsed aerated treatment reactor.

A controller can be employed to receive the signals and use the signals from a probe or sensor to generate a command signal to an aeration device. In some embodiments, controllers may be used to generate instructions to an aeration device for increasing, decreasing or maintaining the concentration of dissolved oxygen or the duration of the aerobic period and/or the duration of the anoxic period. An appropriate aeration device in this context is an air or oxygen supplying blower and diffuser providing a steady oxygen uptake to a treatment reactor during the aerated “on” periods. Aeration devices can further include nozzles, placed at the bottom of the treatment reactor and connected to a pressurized air source by means of a solenoid valve. The aeration device operates under the control of the command signal to modulate the flow of air or the time duration of aeration supplied to the treatment reactor. Thus, the amount of air that is supplied to the reactor is based on the control signal(s) received from the controller. The individual airflow rate supplied to a treatment reactor during an aerated “on” period can vary depending on the size of a given treatment reactor, the size of the wastewater treatment system, and the specific aeration device(s) utilized in the treatment reactor.

In particular embodiments, during an aerated period, the DO concentration can be maintained between two threshold values by interrupting or turning on the air supply in the wastewater treatment reactor. At a predetermined nitrite/ammonium (N—NO₂:N—NH₄) ratio, the aeration is stopped and the nonaerated period, under anoxic conditions, begins at which stage the nitrites produced by the AOB or heterotrophic nitrifiers are converted to nitrogen gas. In some embodiments, as the concentration of nitrogen nears zero the anoxic phase is ended thus completing treatment in the treatment reactor.

In some embodiments, during an anoxic period, oxygen levels are maintained at low concentrations to provide for anoxic conditions in a wastewater treatment reactor. In an exemplary embodiment, during an anoxic period, the DO concentration is maintained between about 0.25 mg/L to about 0.75 mg/L to allow for denitrification. While DO concentration provides a measure of the residual dissolved oxygen in the wastewater, oxidation-reduction potential (ORP) conductivity can be used to measure and maintain the potential of the wastewater during an anoxic period to allow nitrification. Therefore, in some embodiments, during an anoxic period, the ORP potential is maintained between about 125 mV to about 200 mV. However, in some embodiments, the loading rate (i.e., the nitrogen or carbon input into the wastewater treatment system) can shift the preferred values of DO and ORP maintained during an anoxic period to allow nitrification. In some embodiments, the loading rate can shift the preferred duration of aerobic or anoxic conditions.

In some embodiments, the command signal for generating the intermittent or pulsed air “on” and “off” period durations for an aeration device in an intermittent or pulsed aerated treatment reactor can be generated without the use of sensors. In an exemplary embodiment, the command signal for generating the intermittent or pulsed air “on” and “off” period durations can be generated using a timer device for aeration device control, such as an electric timer capable of controlling aeration blowers or diffuser by turning them on and off. In some embodiments, the “on” and “off” period durations can be controlled by the timer device using preset and predetermined time durations. In other embodiments, the command signal for generating the intermittent or pulsed air “on” and “off” period durations can be manually generated by an operator.

In some embodiments, the duration of an aerobic and/or an anoxic phase in a treatment reactor is a preset and predetermined period of time that allows for adequate nitrogen elimination yield of the treated wastewater before the wastewater is directed to the next treatment reactor in series. In some embodiments, the duration of an anoxic phase in an intermittent or pulsed aerated treatment reactor is about 30 minutes, 40 minutes, 50 minutes, 60 minutes, 70 minutes 80 minutes, 90 minutes, 100 minutes, 110 minutes, 120 minutes, 130 minutes, 140 minutes, 150 minutes, 160 minutes, 170 minutes, or about 180 minutes. In certain embodiments, the duration of an anoxic phase in an intermittent or pulsed aerated treatment reactor can range from about 60 minutes to about 120 minutes.

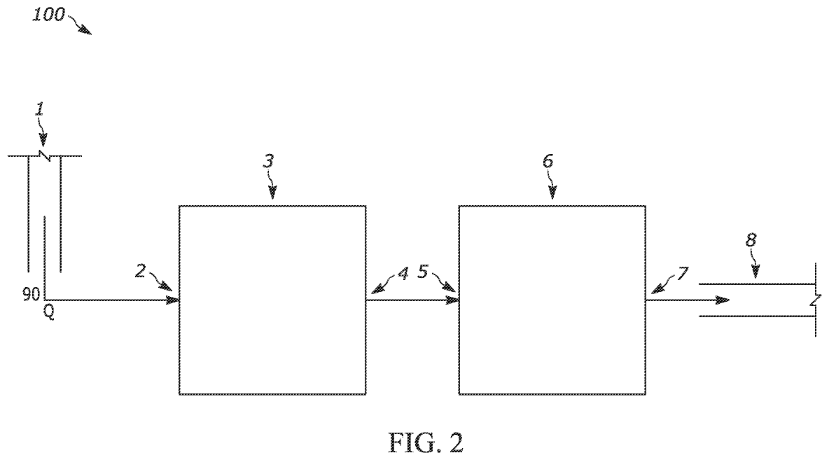

Embodiments of wastewater treatment systems and methods of their operation are described herein and with reference to FIGS. 2-8.

FIG. 2 is a schematic of the flow of wastewater through a wastewater system 100 in accordance with a first embodiment. In this embodiment, wastewater to be treated 90 enters from a wastewater system inlet 1 via a reactor inlet 2 for receiving wastewater into a first wastewater treatment reactor 3. Q represents forward flow of wastewater. Following treatment in the first treatment reactor 3 for a predetermined period, the treated wastewater is directed from the first wastewater treatment reactor outlet 4 to a second treatment reactor inlet 5 of a second treatment reactor 6. Following treatment in the second treatment reactor 6 for a predetermined period, the treated wastewater is directed from the second wastewater treatment reactor outlet 7 to a treated wastewater system outlet 8. The two or more wastewater treatment reactors 3, 6 of the system are selected from anoxic wastewater treatment reactors, flex wastewater treatment reactors, and hydroponic wastewater treatment reactors, wherein (i) either but not both of the anoxic reactor or the flex reactor, (ii) a hydroponic reactor if the anoxic reactor is included, and (iii) at least two flex reactors if the hydroponic reactor is absent, and wherein at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

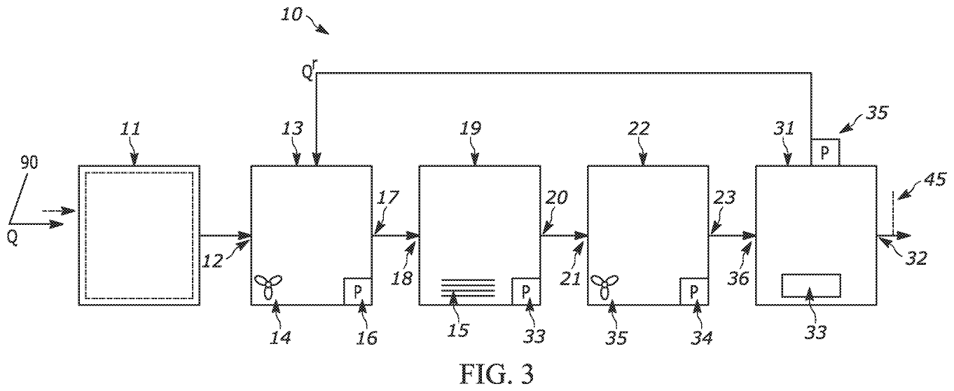

FIG. 3 is a schematic of the flow of wastewater through a wastewater system 10 in accordance with a second embodiment. In this embodiment, wastewater influent 90 enters via a reactor inlet 12 into a first treatment reactor 13, such as, but not intended to be limited to, an anoxic reactor, which as discussed previously achieves removal of organics and solids and denitrification. The first treatment reactor 13 provides treatment stability early in the operational life of the system 10. The first treatment reactor 13 in this system 10 comprises a containment vessel that includes a mixer device for anoxic conditions 14. The anoxic reactor 13 does not include a fixed film as in prior known systems. Nitrogen removal occurs via biodegradation of nitrogen products growing in a suspended growth system in the first treatment reactor 13.

Mixing in the reactor 13, which may be affected by mechanical device, such as a propeller 14, is designed to ensure that wastewater 90 is exchanged substantially throughout the entire containment vessel in a period that may range from minutes to several hours depending upon the characteristics of the reactor 13 and the propeller 14 and solids are kept in suspension. Preferably the mixing occurs substantially continuously during the operation of the system 10 or as needed.

Optionally, the use of a pretreatment module 11 may also be contemplated. In such an embodiment, influent 90 is directed into a pretreatment module 11 and permitted to reside for a predetermined period before the wastewater 90 is directed to an inlet 12 of a first treatment reactor 13 as described above. The pretreatment module 11 may comprise, for example, a covered anaerobic reactor, which serves to perform an initial organic and solids removal. In this pretreatment module 11 the solids from the influent settle, and anaerobic bacteria feed on the solids and wastes in the liquid. A filter can be provided for removing odors from gases or fumes that are produced herein.

Following treatment in the first treatment reactor 13 for a predetermined period, the wastewater is directed via a pump or by gravity flow 16 from a reactor outlet 17 of the first treatment reactor 13 to a reactor inlet 18 of a second treatment reactor 19. A second treatment reactor, such as, but not limited to, an aerobic treatment reactor 19 in this wastewater treatment system 10 comprises a containment vessel that includes an aeration system 15 for aerobic conditions, such as surface aerators or diffusers. The aeration system creates aerobic conditions in the second treatment reactor 19 which allow oxygen to promote beneficial oxygen-feeding bacteria in the wastewater to breakdown organic matter therein.

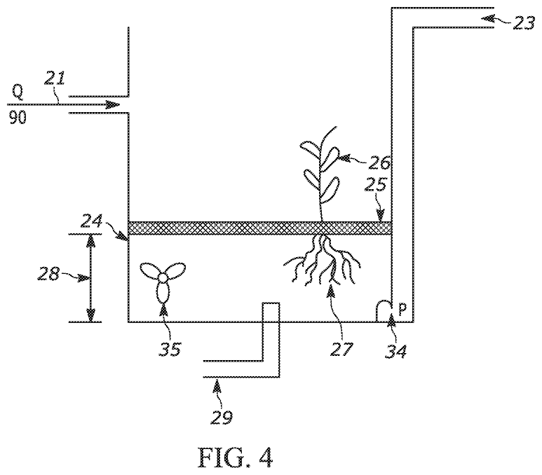

Following treatment in the second treatment reactor 19 for a predetermined period, wastewater is directed via a pump 33 or by gravity flow from a reactor outlet 20 of the second treatment reactor 19 to a reactor inlet 21 of a hydroponic reactor 22 (FIG. 4). A hydroponic reactor 22 herein is intended to comprise a basin 24 having the inlet 21 and an outlet 23. A rack 25 is positionable at the water's surface in the basin 24 and is adapted for supporting plants 26 thereon that send down roots 27 into the wastewater column 28. Preferably the rack 25 covers a high percentage of the basin 24, and plants 26 cover a high percentage of the surface of the rack 25.

The role of plant roots 27 has been determined to be important in the remediation processes of the present system 10 and its alternate embodiments. Plant roots 27 retain significant quantities of biosolids, also known as volatile suspended solids (VSS). Retention of biosolids on plant roots is a key mechanism of the digestion of biosolids within the hydroponic reactor. The aquatic root zone achieves simultaneous nitrification and denitrification. Significant nitrification occurs when nitrifying biosolids are retained on the plant roots 27. Denitrification occurs in localized, transient anoxic sites within the root zone. Further, overall reaction rates are higher than in pure aquatic-root-zone treatment. Since the system 10 does not employ a clarifier, as in prior known systems, capital and operating expenses and time are significantly reduced. The amount of time the wastewater is treated in the hydroponic reactor 22 should be sufficient to digest volatile organic material present in the wastewater and bacterial biomass generated in the system 10.

Treatment basin 20 wastewater column depth 28 in relation to average root depth has a significant effect on treatment performance. At least a 15% penetration of the treatment water column 28 by root mass is believed preferable. As a number of plant species have been found that can reliably produce roots 3-4 feet in length, a maximum design wastewater column depth 28 of approximately 20 to 27 feet is feasible for the current system 10. In another embodiment, a wastewater treatment system includes a second hydroponic reactor that directly follows the first hydroponic reactor 22 in series. Alternatively, one very long hydroponic reactor may also be contemplated.

A hydroponic reactor 22 comprises an intermittent or pulsed aeration device 29 for providing oxygen to control nitrification and/or denitrification of treatment microorganisms. The hydroponic reactor also comprises a mixing device, such as a propeller 35, for mixing the contents of the reactor 22 and for forcing contact between the wastewater and the plant roots 27, ensuring that the plant root zone significantly contributes to treatment. Mixing force should not, however, be so robust as to cause the roots to splay outward, thereby decreasing exposed root surface area.

Intermittent or pulsed aeration and mixing of suspended and fixed film bacterial communities in the hydroponic treatment reactor 22 exclude or inhibits the growth of autotrophic nitrite oxidizing bacteria and fosters or promotes alternate nitrogen removal pathways. This ability to control nitrification and/or denitrification of treatment microorganisms in the inventive system 10 allows treatment microorganisms to nitrify and denitrify in a single treatment reactor module 19. This wastewater treatment system 10 offers additional improvements to prior art technologies: by integrating intermittent or pulsed aeration into the hydroponic treatment reactor 22, the use of a fixed film in an anoxic reactor 13 can be omitted thereby reducing cost and complexity of the system.

Following treatment flow through the hydroponic reactor 22, water is directed from a reactor outlet 23 of the hydroponic reactor 22 via a pump 34 or flows by gravity, to a reactor inlet 30 of a vessel 31 that includes a submerged membrane 33 having a vessel inlet 30 and a vessel outlet 32. The vessel outlet 32 of the vessel 31 can serve as a treated wastewater system outlet for discharge 45 of treated wastewater from the system 10. The submerged membrane 33 can include hollow strands or flat sheets of membrane material immersed in the wastewater treatment vessel 31. In some embodiments, a pump is utilized to create a vacuum to pull water molecules into the hollow core of the strands or flat sheets, separating purified water from contaminants. In some embodiments an external membrane or cross-flow membrane system is used in place of the submerged membrane. The submerged membrane 33 or external membrane material can be selected from a polymeric membrane and a ceramic membrane suitable of wastewater treatment. Use of the ceramic membrane achieves a reduction of system energy and chemical consumption and can also improve performance with solids generated in previous treatment modules, such as solids generated in hydroponic reactors. Ceramic membrane trains can be idled when not required due to diurnal or seasonal flow trends thus reducing energy use. The yield from the present system 10 is very low, since three reactor types 13, 19, and 22 having intrinsically low yields in addition to treatment with the submerged membrane are combined.

The discharge 45 may lead to an additional treatment module such as an ultraviolet disinfection device or other disinfection technology. As wastewater passes through the ultraviolet disinfection device, UV light disrupts DNA in bacteria, viruses, molds, algae, and other microorganisms causing cell death or inactivity. Treated wastewater is then discharged. In some embodiments additional water polishing steps are included such as demineralization such as reverse osmosis. The water emerging from the wastewater treatment system 10 is then suitable for reuse. In some embodiments, a sample port is provided for testing of the discharge 45 after emerging from the system.

Recirculation, where Qr of FIG. 3 represents recycle flow, comprises an important feature of the system 10 design. Recirculation may be achieved by any pumping means known in the art, such as a recycling pump 35 and is preferably at least equal to the forward flow rate and may be up to ten times the forward flow rate. In the embodiment of FIG. 3, recirculation occurs following the vessel 31 that includes a submerged membrane 33 where recycling is directed to the first treatment reactor, prior to directing treated wastewater effluent from the submerged membrane tank through the outlet 32 of the vessel 31 where the discharge 45 exits the wastewater treatment system 10. In an alternative embodiment, recirculation is directed to the anaerobic pretreatment module 11.

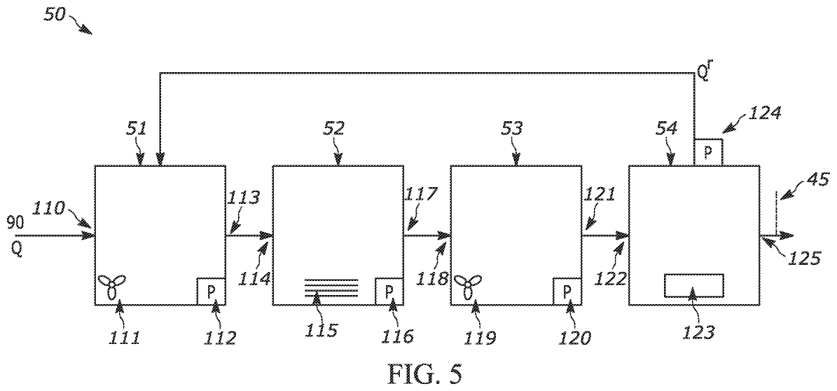

FIG. 5 is a schematic of the flow of wastewater through a wastewater system 50 in accordance with a third embodiment. In this embodiment, wastewater influent 90 enters via a reactor inlet 110 into a flex reactor 51. The flex reactor 51 includes a mixer device, such as a propeller 111 where mixing occurs during operation of the system in cooperation with intermittent or pulsed aeration to allow for the flex reactor 51 to alternate between substantially anoxic and aerobic conditions as needed.

Following treatment in the flex reactor 51 for a period of time, the wastewater is directed via a pump 112 or by gravity flow from the flex reactor outlet 113 to an aerobic reactor 52 via an aerobic reactor inlet 114. The aerobic reactor 52 in this wastewater treatment system 50 comprises an aeration system 115 to maintain a substantially aerobic conditions in the aerobic reactor 52 which allow oxygen to promote beneficial oxygen-feeding bacteria in the wastewater to breakdown organic matter therein.

Following treatment in the aerobic reactor 52 for a period of time, wastewater is directed via a pump 116 or by gravity flow from the aerobic reactor outlet 117 to a reactor inlet 118 of a hydroponic reactor 53 and is substantially the same as that of 22 described above. The hydroponic reactor 53 includes a mixing device, such as a propeller 119. Both the flex reactor 51 and the hydroponic reactor 53 utilize intermittent or pulsed aeration.

Following aquatic-root-zone treatment in the hydroponic reactor 53, wastewater is directed from a reactor outlet 121 of the hydroponic reactor 53 via a pump 120 to an inlet 122 of a vessel 54, such as the vessel 31 described above, that includes a submerged membrane 123 to remove any remaining suspended solids.

Following treatment in the vessel 54, treated wastewater is directed from the vessel outlet 125 which can serve as a treated wastewater system outlet for discharge 45 of treated wastewater from the system 50.

Recirculation or recycling, where Qr of FIG. 5 represents recycle flow, comprises an important feature of the system 50 design. Recirculation is achieved by a recycling pump 124 or airlift. In the embodiment of FIG. 5, recirculation occurs following the vessel 54 that includes a submerged membrane 123 where recycling is directed to the flex reactor 51, prior to directing treated wastewater from the submerged membrane tank through the outlet 125 of the vessel 54 where the discharge 45 exits the wastewater treatment system 50. This system 50 offers improvements to prior art technologies: by integrating intermittent aeration into the flex reactor 51 and the hydroponic reactor 53, the use of a fixed film anoxic reactor can be omitted thereby reducing cost and complexity of the system.

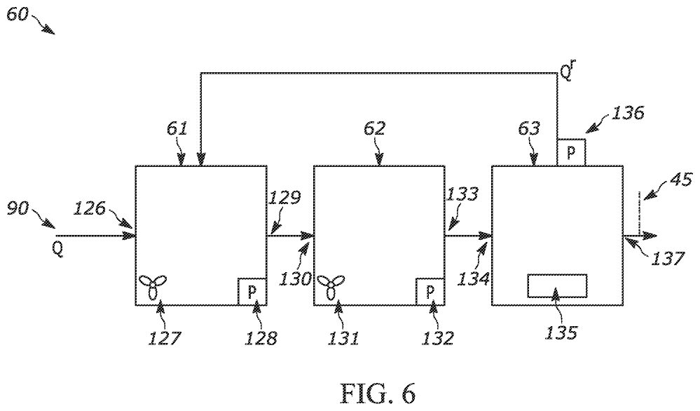

FIG. 6 is a schematic of the flow of wastewater through a wastewater system 60 in accordance with a fourth embodiment. In this embodiment, wastewater influent 90 enters via a reactor inlet 126 into a flex reactor 61. The flex reactor 61 includes a mixer device, such as a propeller 127 where mixing occurs during operation of the system in cooperation with intermittent or pulsed aeration to allow for the flex reactor 61 to alternate between substantially anoxic and aerobic conditions as needed.

Following treatment in the flex reactor 61 for a period of time, the wastewater is directed via a pump 128 or by gravity flow via the flex reactor outlet 129 to a reactor inlet 130 of a hydroponic reactor 62 and is substantially the same as that of 22 described above. The hydroponic reactor 62 includes a mixing device, such as a propeller 131. In this configuration the hydroponic reactor 62 remains in a substantially aerobic condition. Both the flex reactor 61 and the hydroponic reactor 62 utilize intermittent or pulsed aeration.

Following aquatic-root-zone treatment in the hydroponic reactor 62, wastewater is directed from a reactor outlet 133 of the hydroponic reactor 62 via a pump 132 or by gravity flow to an inlet 134 of a vessel 63, such as the vessel 31 described above, that includes a submerged membrane 135 to remove any remaining suspended solids.

Following treatment in the vessel 63, treated wastewater is directed from the vessel outlet 137 which can serve as a treated wastewater system outlet for discharge 45 of treated wastewater from the system 60.

Recirculation or recycling, where Qr of FIG. 6 represents recycle flow, comprises an important feature of the system 60 design. Recirculation is achieved by a recycling pump 136. In the embodiment of FIG. 6, recirculation occurs following flow through the vessel 63 that includes a submerged membrane 135 where recycling is directed to the flex reactor 61, prior to directing treated wastewater from the submerged membrane tank through the outlet 137 of the vessel 63 where the discharge 45 exits the wastewater treatment system 60. This system 60 offers improvements to prior art technologies: by integrating intermittent aeration into the flex reactor 61 and the hydroponic reactor 62, the use of a fixed film anoxic reactor can be omitted thereby reducing cost and complexity of the system.

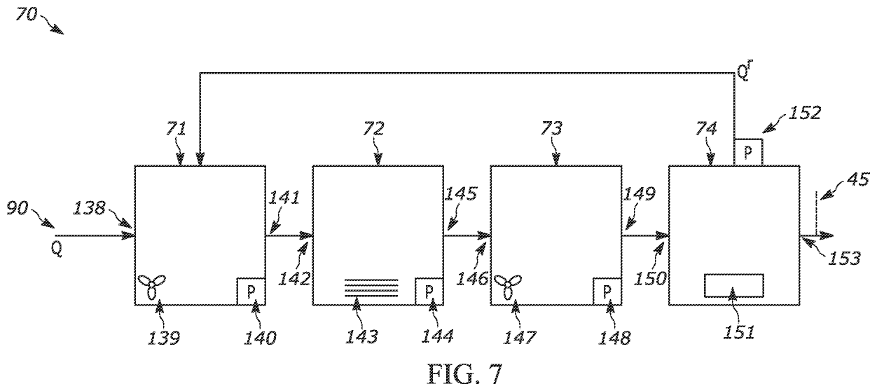

FIG. 7 is a schematic of the flow of wastewater through a wastewater system 70 in accordance with a fifth embodiment. In this wastewater influent 90 entering via a reactor inlet 138 into a flex reactor 71. The flex reactor 71 includes a mixer device, such as a propeller 139 where mixing occurs during operation of the system in cooperation with intermittent or pulsed aeration to allow for the flex reactor 71 to alternate between substantially anoxic and aerobic conditions as needed.

Following treatment in the flex reactor 71 for a period of time, the wastewater is directed via a pump 140 or by gravity flow from the flex reactor 71 through the flex reactor outlet 141 to an aerobic reactor 72 via an aerobic reactor inlet 142. The aerobic reactor 72 in this wastewater treatment system 70 comprises an aeration system 143 to maintain a substantially aerobic conditions in the aerobic reactor 72 which allow oxygen to promote beneficial oxygen-feeding bacteria in the wastewater to breakdown organic matter therein.

Following treatment in the aerobic reactor 72 for a period of time, wastewater is directed via a pump or by gravity flow 144 from the aerobic reactor outlet 145 to a reactor intel 146 of a second flex reactor 73. The second flex reactor includes a mixing device, such as a propeller 147. Both the flex reactor 71 and the flex reactor 73 utilize intermittent or pulsed aeration.

Following treatment in the second flex reactor 73 for a period of time, the wastewater is directed via a pump 148 or by gravity flow from the flex reactor 73 through the flex reactor outlet 149 to an inlet 150 of a vessel 74, such as the vessel 31 described above, that includes a submerged membrane 151 to remove any remaining suspended solids.

Following treatment in the vessel 74, treated wastewater is directed from the vessel outlet 153 which can serve as a treated wastewater system outlet for discharge 45 of treated wastewater from the system 70.

Recirculation or recycling, where Qr of FIG. 7 represents recycle flow, comprises an important feature of the system 70 design. Recirculation is achieved by a recycling pump 152. In the embodiment of FIG. 7, recirculation occurs following flow through the vessel 74 that includes a submerged membrane 151 where recycling is directed to the flex reactor 71, prior to directing treated wastewater from the submerged membrane tank through the outlet 153 of the vessel 74 where the discharge 45 exits the wastewater treatment system 70. This system 70 offers improvements to prior art technologies: by integrating intermittent aeration into multiple flex reactors 71 and 73, the use of a fixed film anoxic reactor can be omitted thereby reducing cost and complexity of the system.

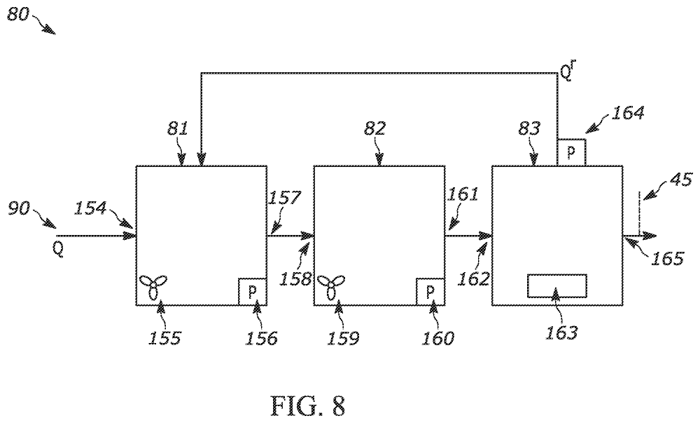

FIG. 8 is a schematic of the flow of wastewater through a wastewater system 60 in accordance with a sixth embodiment. In this embodiment, wastewater influent 90 enters via a reactor inlet 154 into an anoxic reactor 81, such as the anoxic reactor 13 described above, which as discussed previously achieves removal of organics and solids and denitrification. The anoxic treatment reactor 81 provides treatment stability early in the operational life of the system 80. The anoxic reactor 81 includes a mixer device for anoxic conditions 155. The anoxic reactor 81 does not include a fixed film as in prior known systems. Nitrogen removal occurs via biodegradation of nitrogen products growing in a suspended growth system in the first treatment reactor 81. Mixing in the anoxic reactor 81, which may be affected by mechanical device, such as a propeller 155, is designed to ensure that wastewater 90 is exchanged substantially throughout the entire containment vessel of the anoxic reactor 81 in a period that may range from minutes to several hours depending upon the characteristics of the anoxic reactor 81 and the propeller 155. Preferably the mixing occurs substantially continuously during the operation of the system 80 or as needed.

Following treatment in the anoxic reactor 81 for a period of time, the wastewater is directed via a pump 156 or by gravity flow via the anoxic reactor outlet 157 to a reactor inlet 158 of a hydroponic reactor 82 and is substantially the same as that of 22 described above. The hydroponic reactor 82 includes a mixing device, such as a propeller 159. In this configuration the hydroponic reactor 82 remains in a substantially aerobic condition. In this configuration, the hydroponic reactor 82 utilizes intermittent or pulsed aeration.

Following aquatic-root-zone treatment in the hydroponic reactor 82, wastewater is directed from a reactor outlet 161 of the hydroponic reactor 82 via a pump 160 or by gravity flow to an inlet 162 of a vessel 83, such as the vessel 31 described above, that includes a submerged membrane 163 to remove any remaining suspended solids.

Following treatment in the vessel 83, treated wastewater is directed from the vessel outlet 165 which can serve as a treated wastewater system outlet for discharge 45 of treated wastewater from the system 80.

Recirculation or recycling, where Qr of FIG. 8 represents recycle flow, comprises an important feature of the system 80 design. Recirculation is achieved by a recycling pump 164. In the embodiment of FIG. 8, recirculation occurs following flow through the vessel 83 that includes a submerged membrane 163 where recycling is directed to the anoxic reactor 81, prior to directing treated wastewater from the submerged membrane tank through the outlet 165 of the vessel 83 where the discharge 45 exits the wastewater treatment system 80.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system illustrated and described herein are by way of example, and the scope of the invention is not limited to the exact details of construction. From the above description of the invention, those skilled in the art will perceive improvements, changes and modifications. Such improvements, changes and modifications within the skill of the art are intended to be covered by the appended claims.

Having described the invention, the following is claimed:

1. A wastewater treatment system comprising:
two or more wastewater treatment reactors selected from an anoxic wastewater treatment reactor, a flex wastewater treatment reactor, and a hydroponic wastewater treatment reactor in fluid communication with and connecting a wastewater system inlet and a treated wastewater system outlet, each of the anoxic reactor, the flex reactor, or the hydroponic reactor including a reactor inlet for receiving wastewater to be treated and a reactor outlet directing treated wastewater from the anoxic reactor, the flex reactor, or the hydroponic reactor, wherein the system includes: (i) either but not both of the anoxic reactor or the flex reactor, (ii) a hydroponic reactor if the anoxic reactor is included, and (iii) at least two flex reactors if the hydroponic reactor is absent, and wherein at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

2. The system of claim 1, wherein the anoxic reactor includes a mechanical mixing device, and wherein the anoxic reactor does not include a fixed film.

3. The system of claim 1, wherein the intermittent or pulsed aeration device and/or the submerged membrane or submerged root zone of at least one of the flex reactor or the hydroponic reactor allows for simultaneous nitrification and denitrification (SND) in the individual flex reactor or hydroponic reactor.

4. The system of claim 1, wherein the flex reactor and the hydroponic reactor both include an intermittent or pulsed aeration device, and wherein the intermittent or pulsed aeration devices of both the flex wastewater treatment reactor and the hydroponic wastewater reactor are components of a single intermittent or pulsed aeration system.

5. The system of claim 1, wherein the flex reactor and hydroponic reactor do not include an intermittent or pulsed aeration device.

6. The system of claim 1, wherein the hydroponic reactor comprises a basin that defines inlet and an outlet, and includes a rack positionable at a surface of water in the basin for supporting plants thereon, wherein the rack covers substantially the entire surface of the basin and, in use, plants cover about 50% or more of the surface area of the rack, and wherein plants in the hydroponic reactor are adapted to retain biofilms on roots for enhancing nutrient removal.

7. The system of claim 1, further comprising a submerged membrane tank or external membrane system in fluid communication with and downstream of the two or more wastewater treatment reactors, wherein a portion of the water exiting from the submerged membrane tank or external membrane system is directed to at least one of the two or more wastewater treatment reactors upstream of the submerged membrane or external membrane system for further treatment.

8. The system of claim 1, further comprising one or more additional wastewater treatment reactors in fluid communication with and connected to the two or more wastewater treatment reactors.

9. A method of treating wastewater comprising the steps of:
treating wastewater with two or more wastewater treatment reactors selected from an anoxic wastewater treatment reactor, flex wastewater treatment reactor, or hydroponic wastewater treatment reactor, each of the anoxic reactor, the flex reactor, or the hydroponic reactor, wherein the wastewater is treated with: (i) either but not both of the anoxic reactor or the flex reactor, (ii) a hydroponic reactor if the wastewater is not treated with anoxic reactor, and (iii) at least two flex reactors if the wastewater is not treated with the hydroponic reactor, and wherein at least one of the flex reactor or the hydroponic reactor includes an intermittent or pulsed aeration device and/or a submerged membrane or submerged root zone that achieves a natural gradient of oxidative states that is similar to oxidative states achieved using the intermittent or pulsed aeration device.

10. The method of claim 9, mechanically mixing wastewater in the anoxic reactor, and wherein the anoxic reactor does not include a fixed film.

11. The method of claim 9, wherein the wastewater treated in at least one of the flex reactor or the hydroponic reactor is treated using simultaneous nitrification and denitrification (SND) in the individual flex reactor or hydroponic reactor.

12. The method of claim 9, wherein wastewater treated in both the flex reactor and the hydroponic reactor is intermittently or pulse aerated, and wherein the intermittent or pulsed aeration devices of both the flex wastewater treatment reactor and the hydroponic wastewater reactor are components of a single intermittent or pulsed aeration system.

13. The method of claim 9, wherein wastewater treated in the flex reactor and the hydroponic reactor is not intermittently or pulse aerated.

14. The method of claim 9, wherein the hydroponic reactor comprises a basin that defines inlet and an outlet, and includes a rack positionable at a surface of water in the basin for supporting plants thereon, wherein the rack covers substantially the entire surface of the basin and, in use, plants cover about 50% or more of the surface area of the rack, and wherein plants in the hydroponic reactor are adapted to retain biofilms on roots for enhancing nutrient removal.

15. The method of claim 9, wherein the wastewater is further treated in a submerged membrane tank or external membrane system in fluid communication with and downstream of the two or more wastewater treatment reactors, wherein a portion of the wastewater exiting from the submerged membrane tank or external membrane system is treated in at least one of the two or more wastewater treatment reactors upstream of the submerged membrane for further treatment.

16. The method of claim 9, wherein the wastewater is treated in one or more additional wastewater treatment reactors in fluid communication with and connected to the two or more wastewater treatment reactors.

17. The method of claim 9, wherein treatment of wastewater in at least one of the flex reactor or the hydroponic reactor includes intermittently or pulse aerating the wastewater and regulating intermittent or pulsed aeration according to the measurement or detection of a variable in the wastewater treatment reactor.

18. The method as claimed in claim 17, further comprising controlling the duration of an aeration period of intermittent or pulsed aeration by measuring or detecting a variable in the wastewater treatment reactor, and interrupting the air supply if a threshold value of the measured or detected variable is reached before a set period of time, wherein the measured or detected variable is selected from a level of dissolved oxygen (DO), oxidation-reduction potential (ORP), conductivity, temperature, pH, ammonia concentration, nitrite concentration, nitrate concentration, ratio of ammonia concentration to an oxidized nitrogen (NOx) concentration, and combinations thereof.

19. The method of claim 9, wherein treatment of wastewater in at least one of the flex reactor or the hydroponic reactor includes intermittently or pulse aerating the wastewater and regulating intermittent or pulsed aeration using a timer device.

20. The method of claim 9, wherein treatment of wastewater in at least one of the flex reactor or the hydroponic reactor includes an anoxic duration of treatment where the DO concentration of the wastewater is maintained between about 0.25 mg/L and about 0.75 mg/L and/or where the ORP of the wastewater is maintained between about 125 mV and about 200 mV.
